(19) United States
(12) Patent Application Publication
(10) Pub. No.: US 2024/0078124 A1
(43) Pub. Date: Mar. 7, 2024

(54) SYSTEMS AND METHODS FOR CONFIGURING A VIRTUAL COMPUTE INSTANCE IN DIFFERENT CLOUD COMPUTING ENVIRONMENTS

(71) Applicant: Verizon Patent and Licensing Inc., Basking Ridge, NJ (US)

(72) Inventor: Christopher Michael MAPES, Decatur, GA (US)

(73) Assignee: Verizon Patent and Licensing Inc., Basking Ridge, NJ (US)

(21) Appl. No.: 17/930,132

(22) Filed: Sep. 7, 2022

(51) Int. Cl. G06F 9/455

(52) U.S. Cl. CPC G06F 9/45558; G06F 2009/45562; G06F 2009/45579; G06F 2009/45595

(57) ABSTRACT

A device associated with a cloud computing environment may receive a selection of a modified template with a cloning agent, and may generate a modified template clone, with the cloning agent, based on the selection of the modified template. The device may analyze, via the cloning agent, virtual hardware of the cloud computing environment to generate fingerprints, and may identify, via the cloning agent, the cloud computing environment based on the fingerprints. The device may determine, via the cloning agent, one or more application programming interfaces based on identification of the cloud computing environment, and may utilize, via the cloning agent, the one or more application programming interfaces to obtain configuration data. The device may configure, via the cloning agent, a virtual machine of the modified template clone, based on the configuration data and to generate a configured virtual machine, and may enable the configured virtual machine to be utilized.

### BACKGROUND

A cloud computing environment provides on-demand availability of computing system resources (e.g., data storage and computing power) without direct active management by a user. Large cloud computing environments include functions distributed over multiple locations, with each location being a data center.

### BRIEF DESCRIPTION OF THE DRAWINGS

FIGS. 1A-1H are diagrams of an example associated with configuring a virtual compute instance in different cloud computing environments.

FIG. 2 is a diagram of an example environment in which systems and/or methods described herein may be implemented.

FIG. 3 is a diagram of example components of one or more devices of FIG. 2.

FIG. 4 is a flowchart of an example process for configuring a virtual compute instance in different cloud computing environments.

### DETAILED DESCRIPTION OF EXAMPLE EMBODIMENTS

The following detailed description of example implementations refers to the accompanying drawings. The same reference numbers in different drawings may identify the same or similar elements.

An entity may utilize multiple public and private compute providers (e.g., Infrastructure-as-a-Service (IaaS) or cloud computing environments), such as Amazon Web Services (AWS), Oracle Cloud Infrastructure (OCI), VMware Cloud on AWS (VMC), Google Cloud Platform (GCP), Microsoft Azure, VMware, and/or the like. An entity may also utilize hardware-based virtualization, such as Solaris containers, domains, and/or zones; HP-UX virtual partitions (vPARs); AIX logical partitions (LPARs); and/or the like. In order to make provisioning a virtual compute instance as fast as possible, applications and tools are included in templates (e.g., golden images). These templates are then cloned (e.g., copied) to create new virtual compute instances. After a virtual compute instance is created, some applications and tools require additional actions to prepare the virtual compute instance for use.

An alternative method is to re-implement cloning automation for each cloud computing environment. This is necessary because each cloud computing environment has unique application programming interfaces (APIs), processes, and procedures that must be followed in order to support cloning. For example, one cloud computing environment might only support Python code, another cloud computing environment might support PowerShell, and yet another cloud computing environment might support JavaScript.

Thus, current techniques for implementing a virtual compute instance in a cloud computing environment consume computing resources (e.g., processing resources, memory resources, communication resources, and/or the like), networking resources, and/or other resources associated with allocating significant developer resources and time for implementing a virtual compute instance in different cloud computing environments, utilizing resources to support implementing a virtual compute instance in different cloud computing environments, generating multiple points of failure for a virtual compute instance, providing inconsistent and more complicated troubleshooting due to the varied implementations required by different cloud computing environments, and/or the like.

Some implementations described herein provide a compute cloning system (e.g., provided in different cloud computing environments) that configures a virtual compute instance in different cloud computing environments. For example, the compute cloning system may provide, to a device, a plurality of base templates for virtual machines to be implemented in a cloud computing environment associated with the device, and may receive, from the device, a plurality of modified templates that include a cloning agent. The compute cloning system may store the plurality of modified templates in a repository, and may receive a selection of a modified template, with the cloning agent, from the plurality of modified templates stored in the repository. The compute cloning system may generate a modified template clone, with the cloning agent, based on the selection of the modified template, and may analyze, via the cloning agent, virtual hardware of the cloud computing environment to generate fingerprints of the virtual hardware. The compute cloning system may identify, via the cloning agent, the cloud computing environment based on the fingerprints of the virtual hardware, and may determine, via the cloning agent, one or more application programming interfaces based on identification of the cloud computing environment. The compute cloning system may utilize, via the cloning agent, the one or more application programming interfaces to obtain configuration data, and may configure, via the cloning agent, a virtual machine of the modified template clone, based on the configuration data and to generate a configured virtual machine. The compute cloning system may enable the configured virtual machine to be utilized.

In this way, the compute cloning system configures a virtual compute instance in different cloud computing environments. For example, the compute cloning system may receive a modified template that includes a cloning agent. The cloning agent may cause the compute cloning system to detect whenever a virtual compute instance (e.g., a server device) is cloned and to execute any needed actions (e.g., configuration) to prepare the virtual compute instance for use. The cloning agent may be utilized in and be knowledgeable of different cloud computing environments, and may perform the needed actions inside the virtual compute instance. Thus, the compute cloning system may conserve computing resources, networking resources, and/or other resources that would have otherwise been consumed by allocating significant developer resources and time for implementing a virtual compute instance in different cloud computing environments, utilizing resources to support implementing a virtual compute instance in different cloud computing environments, generating multiple points of failure for a virtual compute instance, providing inconsistent and more complicated troubleshooting due to the varied implementations required by different cloud computing environments, and/or the like.

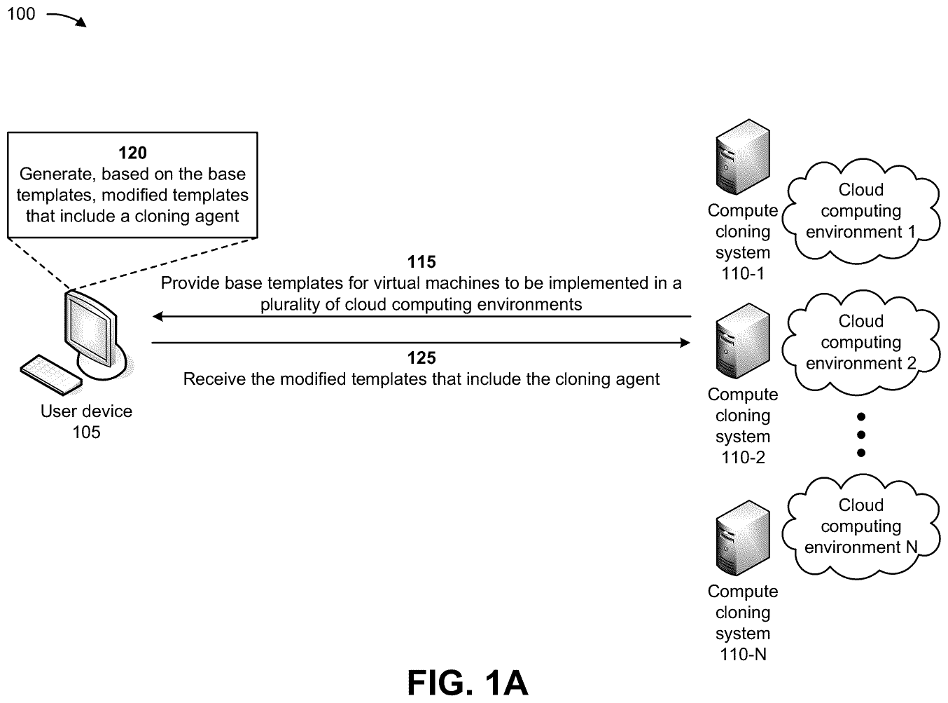

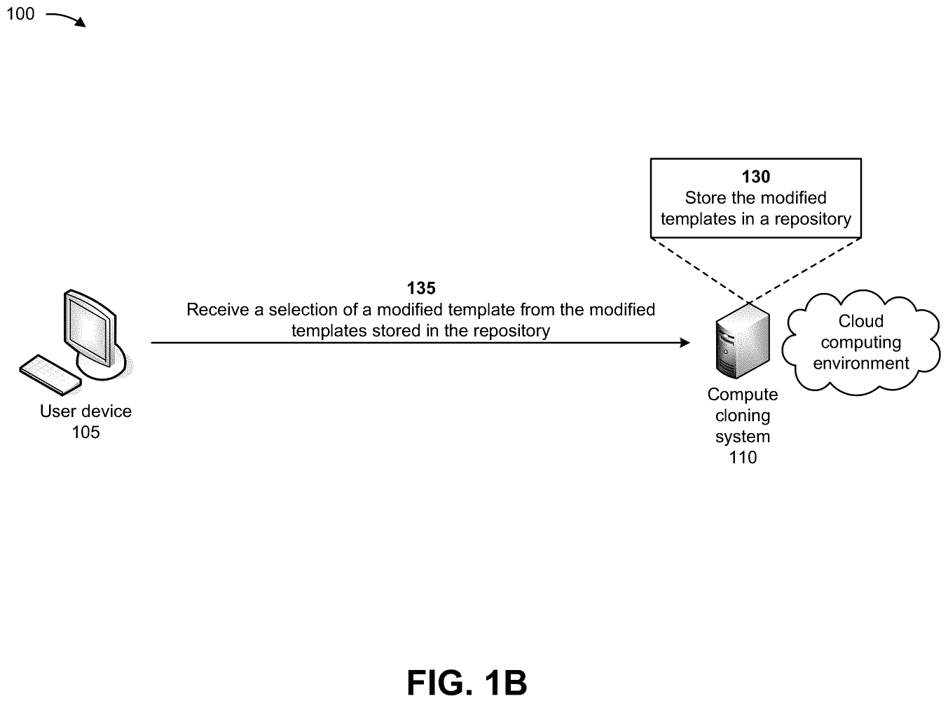

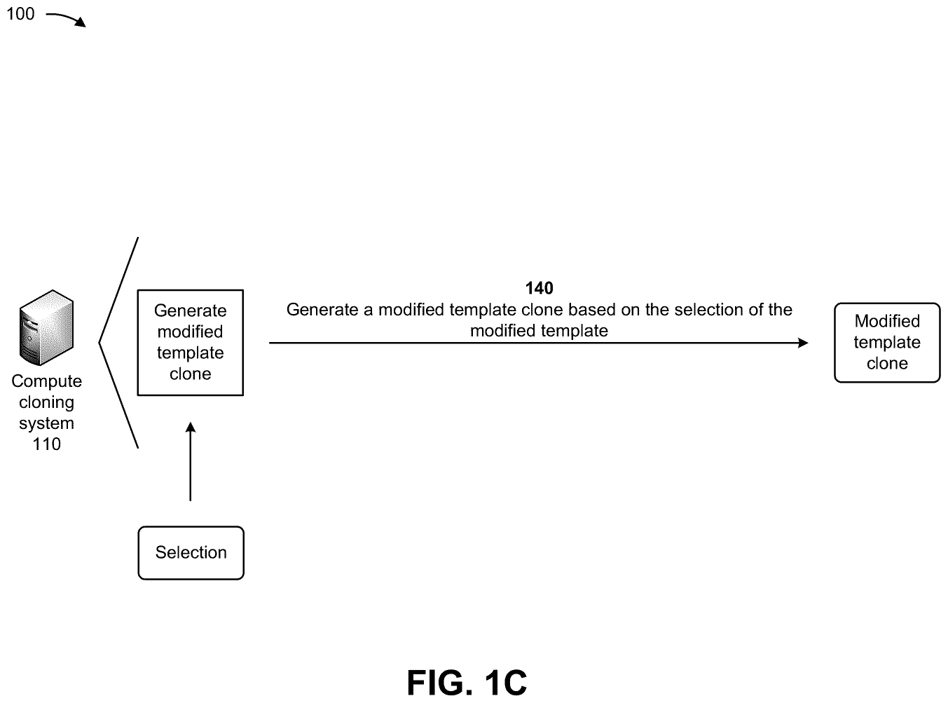

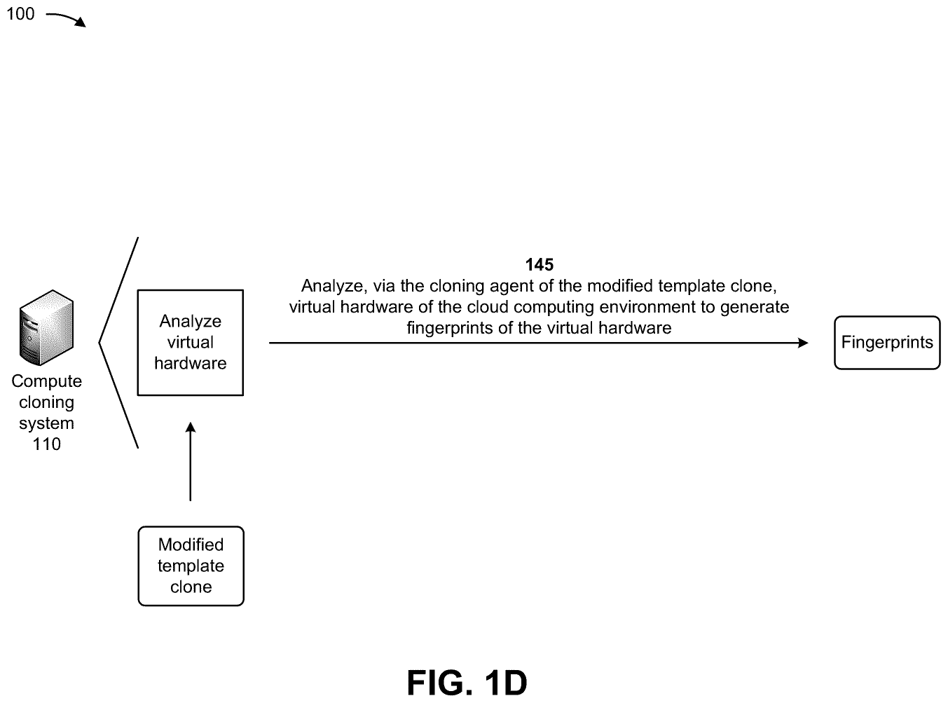

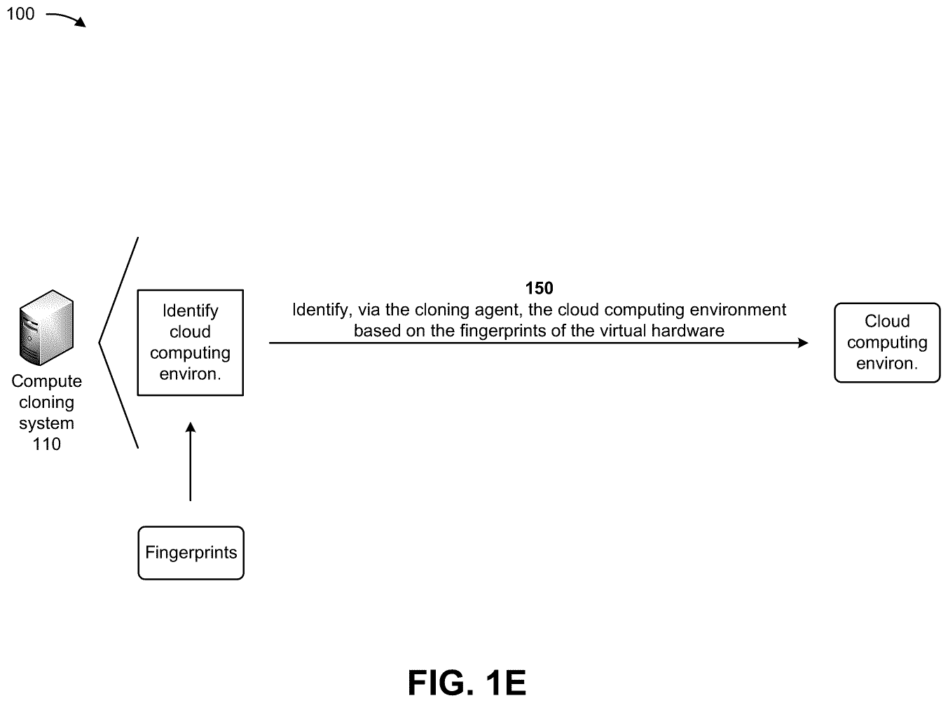

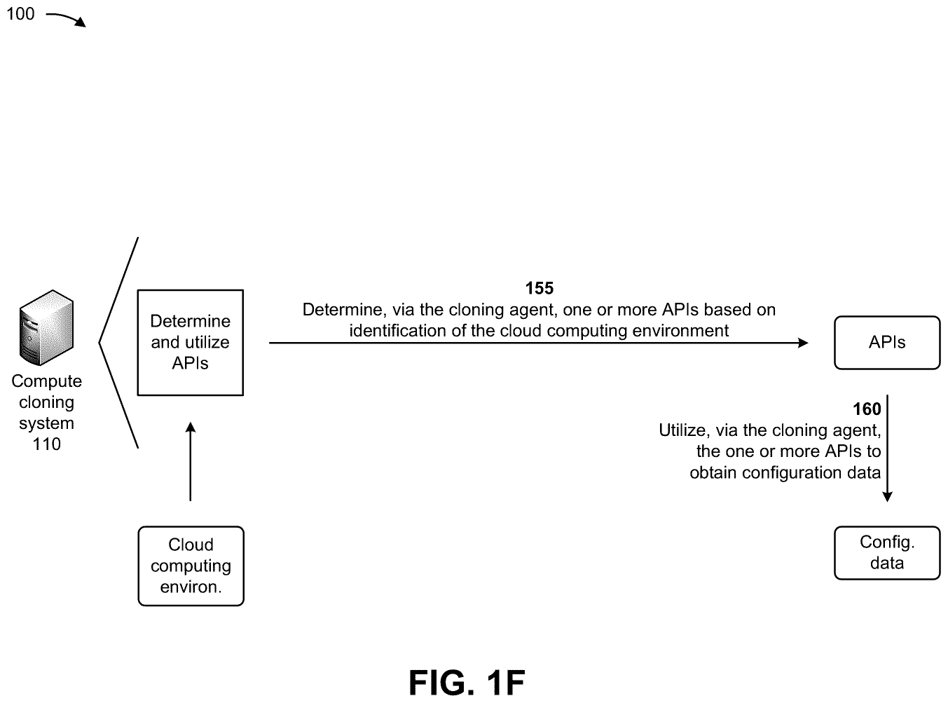

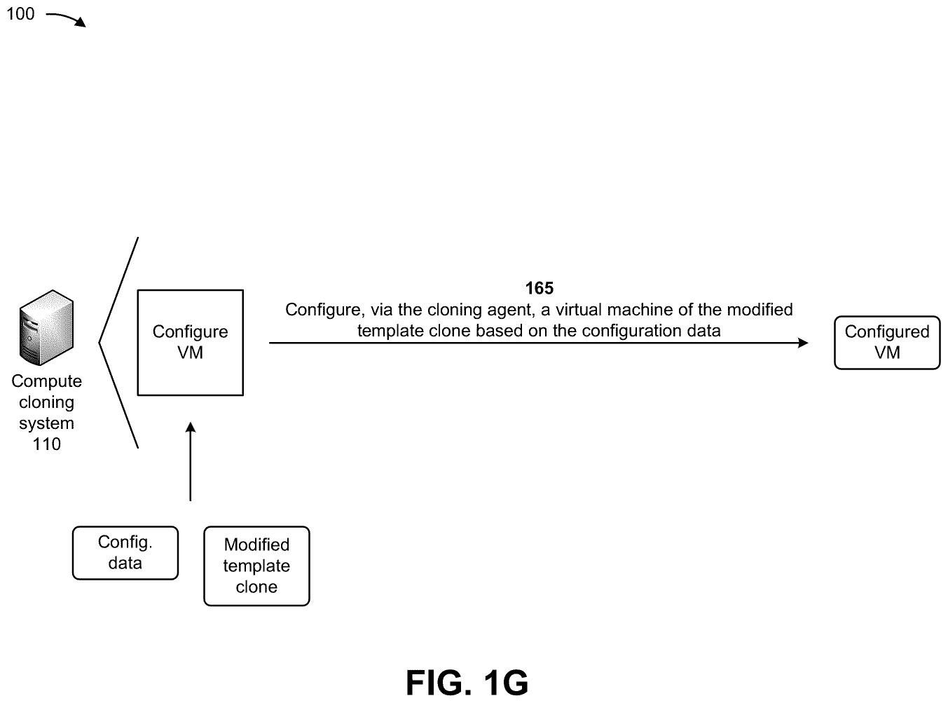

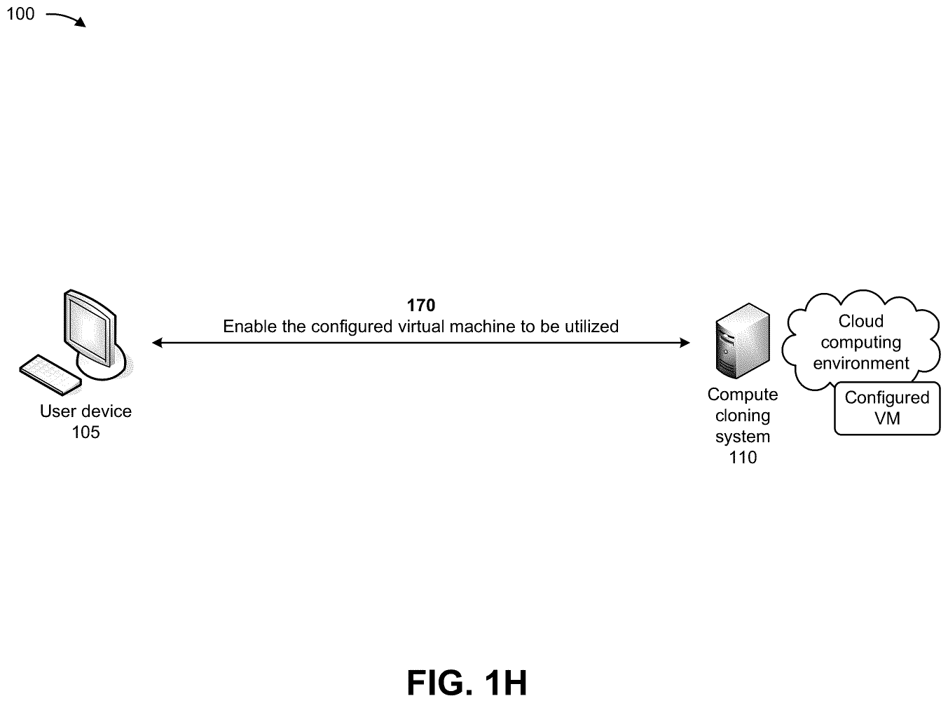

FIGS. 1A-1H are diagrams of an example 100 associated with configuring a virtual compute instance in different cloud computing environments. As shown in FIGS. 1A-1H, example 100 includes a user device 105 associated with a plurality of compute cloning systems 110-1 through 110-N (also referred to as compute cloning systems 110, or singularly as compute cloning system 110). Each of the compute cloning systems 110 may be associated with a corresponding cloud computing environment (e.g., a plurality of cloud computing environments 1 through N). Each of the cloud computing environments utilizes unique APIs, processes, and procedures that must be followed in order to support cloning. Further details of the user device 105, the compute cloning systems 110, and the cloud computing environments are provided elsewhere herein.

As shown in FIG. 1A, and by reference number 115, the plurality of compute cloning systems 110 may provide base templates for virtual machines to be implemented in the plurality of cloud computing environments. For example, in order to make provisioning virtual compute instances (e.g., virtual machines) in the cloud computing environments as fast as possible, the plurality of compute cloning systems 110 may include applications and tools in base templates (e.g., golden images). The applications and tools included in the base templates may be utilized to provision virtual machines in the plurality of cloud computing environments. The plurality of compute cloning systems 110 may provide the base templates to the user device 105, and the user device 105 may receive the base templates. Although implementations are described in connection with the user device 105, in some implementations, the base templates may be received by server devices associated with entities that utilize services of the cloud computing environment.

As further shown in FIG. 1A, and by reference number 120, the user device 105 may generate, based on the base templates, modified templates that include a cloning agent. For example, the user device 105 may customize the base templates to include features (e.g., applications, tools, capabilities, and/or the like) to be provided in the virtual compute instances generated from the base templates. The user device 105 may also customize the base templates to include the cloning agent. The customized base templates with the features and the cloning agent may correspond to the modified templates. The cloning agent may cause the plurality of compute cloning systems 110 to perform functionality described elsewhere herein when the modified templates are utilized to provision the virtual compute instances.

As further shown in FIG. 1A, and by reference number 125, the plurality of compute cloning systems 110 may receive the modified templates that include the cloning agent. For example, the user device 105 may provide the modified templates that include the cloning agent to the plurality of compute cloning systems 110. The plurality of compute cloning systems 110 may receive the modified templates that include the cloning agent from the user device 105. In some implementations, different compute cloning agents 110 may receive different modified templates, may receive the same modified templates, may receive all of the modified templates, may receive a portion of the modified templates, and/or the like.

As shown in FIG. 1B, and by reference number 130, the compute cloning system 110 may store the modified templates in a repository. For example, one of the plurality of compute cloning systems 110 may store the modified templates in a repository (e.g., a database, a table, a list, and/or the like) associated with the compute cloning system 110. In a self-service provisioning cloud computing environment, a collection of modified templates (e.g., golden images) may be referred to as a golden repository, a gold catalog, a golden image library, a registry, and/or the like. The repository of modified templates may be made available to users of the cloud computing environment associated with the compute cloning system 110.

As further shown in FIG. 1B, and by reference number 135, the compute cloning system 110 may receive a selection of a modified template from the modified templates stored in the repository. For example, a user of the cloud computing environment associated with the compute cloning system 110 may utilize a device (e.g., the user device 105) to review the modified templates included in the repository. The user may cause the user device 105 to select a modified template from the modified templates stored in the repository. The compute cloning system 110 may receive, from the user device 105, the selection of the modified template from the modified templates stored in the repository.

As shown in FIG. 1C, and by reference number 140, the compute cloning system 110 may generate a modified template clone based on the selection of the modified template. For example, when the compute cloning system 110 receives the selection of the modified template, the computing cloning system 110 may generate a copy of the modified template (e.g., the modified template clone). The modified template clone may include the features of the modified template, including the cloning agent. In some implementations, the compute cloning system 110 may execute the modified template clone, which may cause the cloning agent, included in the modified template clone, to execute.

As shown in FIG. 1D, and by reference number 145, the compute cloning system 110 may analyze, via the cloning agent of the modified template clone, virtual hardware of the cloud computing environment to generate fingerprints of the virtual hardware. For example, execution of the modified template clone and the cloning agent may cause the compute cloning system 110 to analyze the virtual hardware of the cloud computing environment and to generate the fingerprints of the virtual hardware. In some implementations, when analyzing the virtual hardware of the cloud computing environment to generate the fingerprints of the virtual hardware, the compute cloning system 110 may analyze basic input/output system (BIOS) data associated with the cloud computing environment to generate the fingerprints of the virtual hardware.

In some implementations, the fingerprints of the virtual hardware may include data identifying a network card associated with the cloud computing environment, a BIOS vendor associated with the cloud computing environment, a product name associated with the cloud computing environment, a manufacturer associated with the cloud computing environment, an asset tag number associated with the cloud computing environment, a serial number associated with the cloud computing environment, a chassis identifier associated with the cloud computing environment, and/or the like.

As shown in FIG. 1E, and by reference number 150, the compute cloning system 110 may identify, via the cloning agent, the cloud computing environment based on the fingerprints of the virtual hardware. For example, the cloning agent may store virtual hardware data identifying virtual hardware associated with different cloud computing environments (e.g., the plurality of cloud computing environments shown in FIG. 1A). The cloning agent may cause the computing cloning system 110 to compare the fingerprints of the virtual hardware and the virtual hardware data to determine whether the fingerprints of the virtual hardware match the virtual hardware associated with one of the different cloud computing environments. In some implementations, the cloning agent may cause the computing cloning system 110 to determine that the fingerprints of the virtual hardware match the virtual hardware associated with a cloud computing environment, and to identify the cloud computing environment based on the fingerprints of the virtual hardware matching the virtual hardware associated with a cloud computing environment.

As shown in FIG. 1F, and by reference number 155, the compute cloning system 110 may determine, via the cloning agent, one or more APIs based on identification of the cloud computing environment. For example, the cloning agent may include APIs associated with different cloud computing environments (e.g., the plurality of cloud computing environments shown in FIG. 1A). The cloning agent may cause the compute cloning system 110 to determine one or more APIs associated with identified cloud computing environment from the APIs associated with different cloud computing environments. In some implementations, the one or more APIs may include a metadata API configured to obtain an instance identifier associated with a virtual machine to be provisioned in the cloud computing environment based on the modified template clone and a network location associated with the virtual machine, a token API configured to securely call other APIs (e.g., the metadata API) associated with the cloud computing environment, and/or the like.

As further shown in FIG. 1F, and by reference number 160, the compute cloning system 110 may utilize, via the cloning agent, the one or more APIs to obtain configuration data. For example, the cloning agent may cause the compute cloning system 110 to utilize the one or more APIs to obtain configuration data to be utilized to configure the virtual machine of the modified template clone in a usable state in the cloud computing environment. In some implementations, the configuration data may include data for configuring services (e.g., security services) for a virtual machine of the modified template clone, for configuring the virtual machine of the modified template clone to operate in the cloud computing environment, for configuring an operating system for the virtual machine of the modified template clone, and/or the like.

As shown in FIG. 1G, and by reference number 165, the compute cloning system 110 may configure, via the cloning agent, a virtual machine of the modified template clone based on the configuration data. For example, the cloning agent may cause the compute cloning system 110 to configure the virtual machine of the modified template clone based on the configuration data. In some implementations, when configuring the virtual machine of the modified template clone, the computing cloning system 110 may configure the virtual machine of the modified template clone to operate in the cloud computing environment, may configure an operating system for the virtual machine of the modified template clone, may configure security services for the virtual machine of the modified template clone, and/or the like. Once the virtual machine of the modified template clone is configured, the configured virtual machine may be in a usable state in the cloud computing environment.

As shown in FIG. 1H, and by reference number 170, the compute cloning system 110 may enable the configured virtual machine to be utilized. For example, when enabling the configured virtual machine to be utilized, the compute cloning system 110 may enable the user device 105 to utilize the configured virtual machine. The user device 105 may communicate with the configured virtual machine and may utilize the features of the configured virtual machine. In some implementations, the configured virtual machine includes a configured virtual compute instance, such as a virtual desktop, a virtual computing resource (e.g., a virtual server device), a virtual storage device (e.g., a virtual data structure), and/or the like. In some implementations, the cloning agent may execute within an operating system for the virtual machine of the modified template clone to generate the configured virtual machine.

In this way, the compute cloning system 110 configures a virtual compute instance in different cloud computing environments. For example, the compute cloning system 110 may receive a modified template that includes a cloning agent. The cloning agent may cause the compute cloning system 110 to detect whenever a virtual compute instance is cloned and to execute any needed actions to prepare the virtual compute instance for use. The cloning agent may be utilized in and be knowledgeable of different cloud computing environments, and may perform the needed actions inside the virtual compute instance. Thus, the compute cloning system 110 may conserve computing resources, networking resources, and/or other resources that would have otherwise been consumed by allocating significant developer resources and time for implementing a virtual compute instance in different cloud computing environments, utilizing resources to support implementing a virtual compute instance in different cloud computing environments, generating multiple points of failure for a virtual compute instance, providing inconsistent and more complicated troubleshooting due to the varied implementations required by different cloud computing environments, and/or the like.

As indicated above, FIGS. 1A-1H are provided as an example. Other examples may differ from what is described with regard to FIGS. 1A-1H. The number and arrangement of devices shown in FIGS. 1A-1H are provided as an example. In practice, there may be additional devices, fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

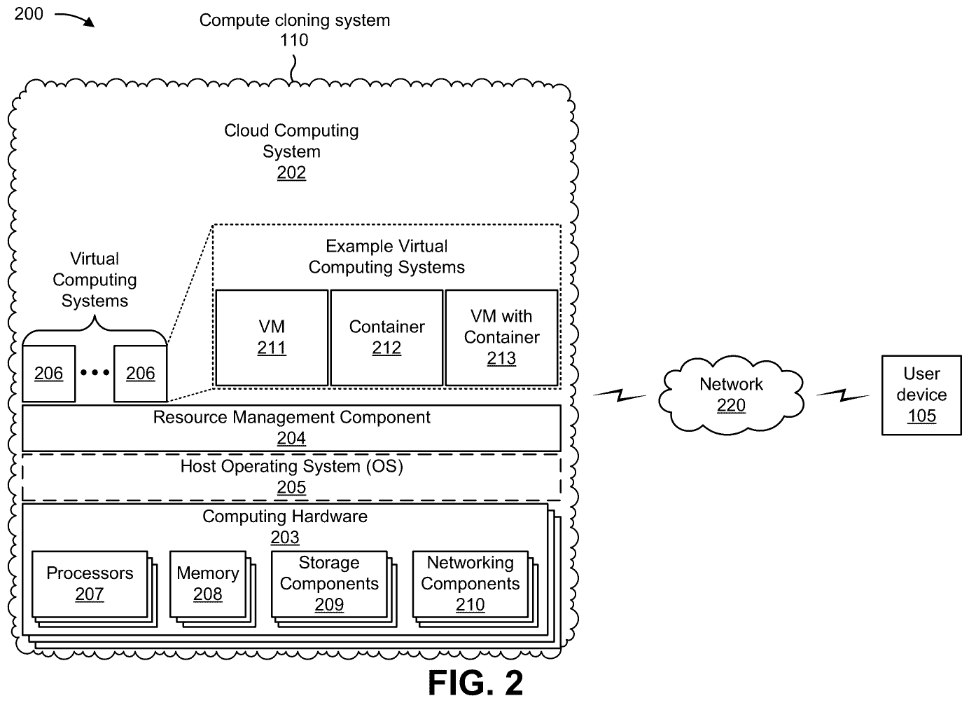

FIG. 2 is a diagram of an example environment 200 in which systems and/or methods described herein may be implemented. As shown in FIG. 2, the environment 200 may include the compute cloning system 110, which may include one or more elements of and/or may execute within a cloud computing system 202. The cloud computing system 202 may include one or more elements 203-213, as described in more detail below. As further shown in FIG. 2, the environment 200 may include the user device 105 and/or a network 220. Devices and/or elements of the environment 200 may interconnect via wired connections and/or wireless connections.

The user device 105 includes one or more devices capable of receiving, generating, storing, processing, and/or providing information, such as information described herein. For example, the user device 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

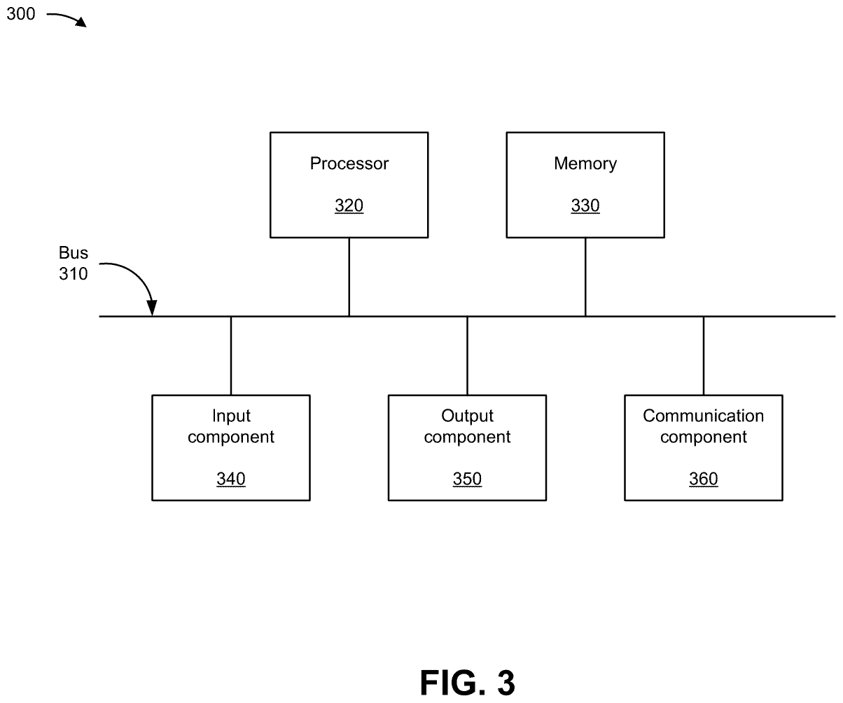

Although the compute cloning system 110 may include one or more elements 203-213 of the cloud computing system 202, may execute within the cloud computing system 202, and/or may be hosted within the cloud computing system 202, in some implementations, the compute cloning system 110 may not be cloud-based (e.g., may be implemented outside of a cloud computing system) or may be partially cloud-based. For example, the compute cloning system 110 may include one or more devices that are not part of the cloud computing system 202, such as the device 300 of FIG. 3, which may include a standalone server or another type of computing device. The compute cloning system 110 may perform one or more operations and/or processes described in more detail elsewhere herein.

The network 220 may include one or more wired and/or wireless networks. For example, the network 220 may include a cellular network (e.g., a fifth generation (5G) network, a fourth generation (4G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 220 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105 and/or the compute cloning system 110. In some implementations, the user device 105 and/or the compute cloning system 110 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

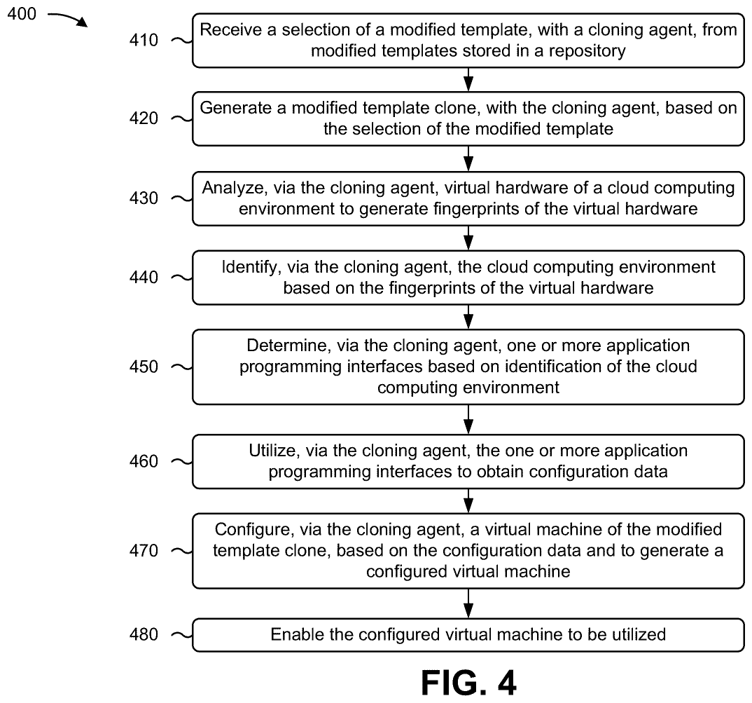

FIG. 4 is a flowchart of an example process 400 for configuring a virtual compute instance in different cloud computing environments. In some implementations, one or more process blocks of FIG. 4 may be performed by a device (e.g., the compute cloning system 110). In some implementations, one or more process blocks of FIG. 4 may be performed by another device or a group of devices separate from or including the device, such as a user device (e.g., the user device 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving a selection of a modified template, with a cloning agent, from modified templates stored in a repository (block 410). For example, the device may receive a selection of a modified template, with a cloning agent, from modified templates stored in a repository, as described above. In some implementations, receiving the selection of the modified template includes receiving the selection of the modified template from the plurality of modified templates stored in the repository.

As further shown in FIG. 4, process 400 may include generating a modified template clone, with the cloning agent, based on the selection of the modified template (block 420). For example, the device may generate a modified template clone, with the cloning agent, based on the selection of the modified template, as described above.

As further shown in FIG. 4, process 400 may include analyzing, via the cloning agent, virtual hardware of the cloud computing environment to generate fingerprints of the virtual hardware (block 430). For example, the device may analyze, via the cloning agent, virtual hardware of the cloud computing environment to generate fingerprints of the virtual hardware, as described above. In some implementations, analyzing the virtual hardware of the cloud computing environment to generate the fingerprints of the virtual hardware includes analyzing basic input/output system data associated with the cloud computing environment. In some implementations, the fingerprints of the virtual hardware include data identifying one or more of a network card associated with the cloud computing environment, a basic input/output system vendor associated with the cloud computing environment, a product name associated with the cloud computing environment, a manufacturer associated with the cloud computing environment, an asset tag number associated with the cloud computing environment, a serial number associated with the cloud computing environment, or a chassis identifier associated with the cloud computing environment.

As further shown in FIG. 4, process 400 may include identifying, via the cloning agent, the cloud computing environment based on the fingerprints of the virtual hardware (block 440). For example, the device may identify, via the cloning agent, the cloud computing environment based on the fingerprints of the virtual hardware, as described above.

As further shown in FIG. 4, process 400 may include determining, via the cloning agent, one or more application programming interfaces based on identification of the cloud computing environment (block 450). For example, the device may determine, via the cloning agent, one or more application programming interfaces based on identification of the cloud computing environment, as described above. In some implementations, the one or more application programming interfaces include a metadata application programming interface configured to obtain an instance identifier associated with the virtual machine and a network location associated with the virtual machine. In some implementations, the one or more application programming interfaces include a token application programming interface configured to securely call other application programming interfaces.

As further shown in FIG. 4, process 400 may include utilizing, via the cloning agent, the one or more application programming interfaces to obtain configuration data (block 460). For example, the device may utilize, via the cloning agent, the one or more application programming interfaces to obtain configuration data, as described above.

As further shown in FIG. 4, process 400 may include configuring, via the cloning agent, a virtual machine of the modified template clone, based on the configuration data and to generate a configured virtual machine (block 470). For example, the device may configure, via the cloning agent, a virtual machine of the modified template clone, based on the configuration data and to generate a configured virtual machine, as described above. In some implementations, configuring the virtual machine of the modified template clone includes configuring the virtual machine of the modified template clone to operate in the cloud computing environment, and configuring an operating system for the virtual machine of the modified template clone. In some implementations, the configured virtual machine includes a configured virtual compute instance. In some implementations, the cloning agent executes within an operating system for the virtual machine of the modified template clone.

As further shown in FIG. 4, process 400 may include enabling the configured virtual machine to be utilized (block 480). For example, the device may enable the configured virtual machine to be utilized, as described above. In some implementations, enabling the configured virtual machine to be utilized includes enabling a user device to utilize the configured virtual machine.

In some implementations, process 400 includes providing, to another device, a plurality of base templates for virtual machines to be implemented in the cloud computing environment, receiving, from the other device, a plurality of modified templates that include the cloning agent, and storing the plurality of modified templates in the repository. In some implementations, providing the plurality of base templates causes the other device to generate the plurality of modified templates that include the cloning agent.

In some implementations, process 400 includes receiving another selection of another modified template with the cloning agent; generating another modified template clone, with the cloning agent, based on the other selection of the other modified template; analyzing, via the cloning agent, the virtual hardware of the cloud computing environment to generate the fingerprints of the virtual hardware; identifying, via the cloning agent, the cloud computing environment based on the fingerprints of the virtual hardware; determining, via the cloning agent, the one or more application programming interfaces based on identification of the cloud computing environment; utilizing, via the cloning agent, the one or more application programming interfaces to obtain additional configuration data; configuring, via the cloning agent, another virtual machine of the other modified template clone, based on the additional configuration data and to generate another configured virtual machine; and enabling the other configured virtual machine to be utilized.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device associated with a cloud computing environment, a selection of a modified template, with a cloning agent, from modified templates stored in a repository;
generating, by the device, a modified template clone, with the cloning agent, based on the selection of the modified template;
analyzing, by the device and via the cloning agent, virtual hardware of the cloud computing environment to generate fingerprints of the virtual hardware;
identifying, by the device and via the cloning agent, the cloud computing environment based on the fingerprints of the virtual hardware;
determining, by the device and via the cloning agent, one or more application programming interfaces based on identification of the cloud computing environment;
utilizing, by the device and via the cloning agent, the one or more application programming interfaces to obtain configuration data;
configuring, by the device and via the cloning agent, a virtual machine of the modified template clone, based on the configuration data and to generate a configured virtual machine; and
enabling, by the device, the configured virtual machine to be utilized.

2. The method of claim 1, further comprising:
providing, to another device, a plurality of base templates for virtual machines to be implemented in the cloud computing environment;
receiving, from the other device, a plurality of modified templates that include the cloning agent; and
storing the plurality of modified templates in the repository.

3. The method of claim 2, wherein providing the plurality of base templates causes the other device to generate the plurality of modified templates that include the cloning agent.

4. The method of claim 2, wherein receiving the selection of the modified template comprises:
receiving the selection of the modified template from the plurality of modified templates stored in the repository.

5. The method of claim 1, wherein analyzing the virtual hardware of the cloud computing environment to generate the fingerprints of the virtual hardware comprises:
analyzing basic input/output system data associated with the cloud computing environment.

6. The device of claim 1, wherein the fingerprints of the virtual hardware include data identifying one or more of:
a network card associated with the cloud computing environment,
a basic input/output system vendor associated with the cloud computing environment,
a product name associated with the cloud computing environment,
a manufacturer associated with the cloud computing environment,
an asset tag number associated with the cloud computing environment,
a serial number associated with the cloud computing environment, or
a chassis identifier associated with the cloud computing environment.

7. The method of claim 1, wherein the one or more application programming interfaces include a metadata application programming interface configured to obtain an instance identifier associated with the virtual machine and a network location associated with the virtual machine.

8. A device, comprising:
one or more processors configured to:
provide, to another device, a plurality of base templates for virtual machines to be implemented in a cloud computing environment associated with the device;
receive, from the other device, a plurality of modified templates that include a cloning agent;
store the plurality of modified templates in a repository;
receive a selection of a modified template, with the cloning agent, from the plurality of modified templates stored in the repository;
generate a modified template clone, with the cloning agent, based on the selection of the modified template;
analyze, via the cloning agent, virtual hardware of the cloud computing environment to generate fingerprints of the virtual hardware;
identify, via the cloning agent, the cloud computing environment based on the fingerprints of the virtual hardware;
determine, via the cloning agent, one or more application programming interfaces based on identification of the cloud computing environment;
utilize, via the cloning agent, the one or more application programming interfaces to obtain configuration data;
configure, via the cloning agent, a virtual machine of the modified template clone, based on the configuration data and to generate a configured virtual machine; and
enable the configured virtual machine to be utilized.

9. The device of claim 8, wherein the one or more application programming interfaces include a token application programming interface configured to securely call other application programming interfaces.

10. The device of claim 8, wherein the one or more processors, to configure the virtual machine of the modified template clone, are configured to:
configure the virtual machine of the modified template clone to operate in the cloud computing environment; and
configure an operating system for the virtual machine of the modified template clone.

11. The device of claim 8, wherein the one or more processors are further configured to:
receive another selection of another modified template with the cloning agent;
generate another modified template clone, with the cloning agent, based on the other selection of the other modified template;
analyze, via the cloning agent, the virtual hardware of the cloud computing environment to generate the fingerprints of the virtual hardware;
identify, via the cloning agent, the cloud computing environment based on the fingerprints of the virtual hardware;
determine, via the cloning agent, the one or more application programming interfaces based on identification of the cloud computing environment;
utilize, via the cloning agent, the one or more application programming interfaces to obtain additional configuration data;
configure, via the cloning agent, another virtual machine of the other modified template clone, based on the additional configuration data and to generate another configured virtual machine; and
enable the other configured virtual machine to be utilized.

12. The device of claim 8, wherein the one or more processors, to enable the configured virtual machine to be utilized, are configured to:
enable a user device to utilize the configured virtual machine.

13. The device of claim 8, wherein the configured virtual machine includes a configured virtual compute instance.

14. The device of claim 8, wherein the cloning agent executes within an operating system for the virtual machine of the modified template clone.

15. A non-transitory computer-readable medium storing a set of instructions, the set of instructions comprising:
one or more instructions that, when executed by one or more processors of a device associated with a cloud computing environment, cause the device to:
store, in a repository, a plurality of modified templates that include a cloning agent;
receive a selection of a modified template, with the cloning agent, from the plurality of modified templates stored in the repository;
generate a modified template clone, with the cloning agent, based on the selection of the modified template;
analyze, via the cloning agent, virtual hardware of the cloud computing environment to generate fingerprints of the virtual hardware;
identify, via the cloning agent, the cloud computing environment based on the fingerprints of the virtual hardware;
determine, via the cloning agent, one or more application programming interfaces based on identification of the cloud computing environment;
utilize, via the cloning agent, the one or more application programming interfaces to obtain configuration data;
configure, via the cloning agent, a virtual machine of the modified template clone, based on the configuration data and to generate a configured virtual machine; and
enable the configured virtual machine to be utilized.

16. The non-transitory computer-readable medium of claim 15, wherein the one or more instructions further cause the device to:
provide, to another device, a plurality of base templates for virtual machines to be implemented in the cloud computing environment; and
receive, from the other device, the plurality of modified templates that include the cloning agent.

17. The non-transitory computer-readable medium of claim 15, wherein the one or more instructions, that cause the device to analyze the virtual hardware of the cloud computing environment to generate the fingerprints of the virtual hardware, cause the device to:
analyze basic input/output system data associated with the cloud computing environment.

18. The non-transitory computer-readable medium of claim 15, wherein the one or more application programming interfaces include:
a metadata application programming interface configured to obtain an instance identifier associated with the virtual machine and a network location associated with the virtual machine, and
a token application programming interface configured to securely call other application programming interfaces.

19. The non-transitory computer-readable medium of claim 15, wherein the one or more instructions, that cause the device to configure the virtual machine of the modified template clone, cause the device to:
configure the virtual machine of the modified template clone to operate in the cloud computing environment; and
configure an operating system for the virtual machine of the modified template clone.

20. The non-transitory computer-readable medium of claim 15, wherein the configured virtual machine includes a configured virtual compute instance.
